(19) United States
(12) Patent Application Publication
(10) Pub. No.: US 2021/0332918 A1
(43) Pub. Date: Oct. 28, 2021

(54) FLUID FITTING COMPRISING DUPLEX STAINLESS STEEL

(71) Applicant: LenLok Holdings, LLC, Willoughby, OH (US)

(72) Inventor: Mark John Sindelar, Shaker Heights, OH (US)

(21) Appl. No.: 17/238,803

(22) Filed: Apr. 23, 2021

Related U.S. Application Data
(60) Provisional application No. 63/014,392, filed on Apr. 23, 2020.

(51) Int. Cl. F16L 19/10

(52) U.S. Cl. CPC F16L 19/10

(57) ABSTRACT

A fluid system includes a fluid fitting for mechanical attachment to a fluid element. The fluid fitting includes a coupling body having an inner surface defining a bore for receiving the fluid element therein, and a seal portion formed on the inner surface for engaging the fluid element. The fluid fitting further includes a ring configured to fit over at least one end of the coupling body. When the ring is installed on the coupling body via force with the fluid element received in the bore, the ring applies a compressive force to the coupling body sufficient to cause permanent deformation of the coupling body such that a tooth of the seal portion bites into the fluid element to thereby attach the fluid element to the coupling body in a non-leaking manner. Moreover, at least one of the fluid element, the coupling body, and the ring includes duplex stainless steel.

### CROSS-REFERENCE TO RELATED APPLICATIONS

This application claims the benefit of U.S. provisional application Ser. No. 63/014,392 filed Apr. 23, 2020, the contents of which are incorporated by reference.

### TECHNICAL FIELD

The present disclosure generally relates to a fluid system including a fluid fitting for mechanical attachment to a fluid element, particularly wherein at least one of the fluid fitting and fluid element includes duplex stainless steel materials.

### BACKGROUND OF THE INVENTION

In current practice, pipes and fittings are commonly attached together by welding. However, such welding techniques inhibit the ability to manufacture the pipes and fittings with materials that either cannot be welded together or require a high degree of skill to weld properly.

For example, duplex stainless steels are noted for their superior corrosion resistance, high strength, sufficient ductility, good reformation, and cost effectiveness as compared to standard austenitic stainless steels. These improved properties are often attributed to the dual phase microstructure of austenite and ferrite of duplex stainless steels. However, duplex stainless steels are less stable at welding temperatures compared to other alloys. Specifically, welding can break down the steels' microstructures, ultimately inboard to decreased corrosion resistance and toughness.

Furthermore, improper welding techniques and procedures can introduce detrimental effects into duplex stainless steel, such as unbalanced ferrite to austenite ratios and the formation of intermetallic phases, which can lead to accelerated corrosion or mechanical failure in the weld zone. These effects can jeopardize a fluid fitting and pipe, particularly in the presence of corrosive process fluids or gases, such as hydrogen sulfide. For example, H₂S in the presence of water can result in damage to steel pipelines in the form of corrosion, cracking, or blistering. The effects of H₂S on steel can result in sulphide stress cracking (SSC), hydrogen induced cracking (HIC), and corrosion. The presence of carbon dioxide tends to increase the corrosion rate in the steel. It may also increase the susceptibility of the steel to both SSC and HIC.

Thus, a high degree of skill and control is required when welding pipes and fittings that comprise duplex stainless steel, and critical steps must be taken to ensure that the steel maintains sufficient corrosion resistance and mechanical properties in the weld zone. Where maximum results are necessary, such as in corrosive service applications, selecting the proper base material and weld filler metal will not guarantee success. Special attention to welding process, welder technique, bead shape, preheat/interpass temperatures, heat input on a per bead basis, and corrosion sample preparation are all required to achieve satisfactory results when welding duplex stainless steels.

### BRIEF SUMMARY OF THE INVENTION

The following presents a simplified summary of example embodiments of the invention. This summary is not intended to identify critical elements or to delineate the scope of the invention.

In accordance with a first aspect, a fluid fitting for mechanical attachment to a fluid element includes a coupling body defining a bore for receiving said fluid element therein, the coupling body including a sleeve portion and a tooth that extends radially inward from the sleeve portion for engaging said fluid element. The fluid fitting further includes a ring configured to fit over at least one end of the coupling body for mechanically attaching the coupling body to said fluid element. When the ring is installed on the at least one end of the coupling body via force with the fluid element received in the bore, the ring applies a compressive force to the coupling body sufficient to cause permanent deformation of the coupling body such that the tooth of the coupling body bites into said fluid element to thereby attach the coupling body to said fluid element in a non-leaking manner. Moreover, at least one of the coupling body and ring includes duplex stainless steel.

In one example of the first aspect, the coupling body and ring both include duplex stainless steel.

In another example of the first aspect, one of the coupling body and the drive ring includes duplex stainless steel, and the other of the coupling body and the drive ring does not include duplex stainless steel.

In yet another example of the first aspect, the duplex stainless steel includes an austenite-to-ferrite ratio of about 35% to about 65%.

In still yet another example of the first aspect, the duplex stainless steel includes a minimum of about 25% mass chromium.

In another example of the first aspect, the duplex stainless steel includes a minimum of about 2% mass molybdenum.

In yet another example of the first aspect, the duplex stainless steel includes a minimum of about 6.5% mass nickel.

In still yet another example of the first aspect, the duplex stainless steel includes a PREN (i.e., Pitting Resistance Equivalent Number) of about 40 or greater.

In another example of the first aspect, the tooth includes a cross-sectional profile that is substantially trapezoidal.

In yet another example of the first aspect, the bore of the coupling body has a central axis that defines an axial direction and a radial direction of the coupling body. The tooth includes an inboard flank, an outboard flank, and a distal face that extends between the inboard flank and outboard flank. Moreover, the inboard flank and the outboard flank extend oblique to the radial direction. In one example, an angle between the radial direction and each of the inboard flank and the outboard flank is about 40 degrees to about 60 degrees. In another example, a cross-sectional profile of the distal face is substantially flat. In yet another example, a cross-sectional profile of the distal face is rounded with a radius of curvature of about 0.010″ to about 0.050″. In still yet another example, a cross-sectional profile of the distal face has a length of about 0.005″ to about 0.040″. In another example, the distal face intersects with the inboard flank and the outboard flank at respective edges, each edge having a radius of curvature of about 0.003″ to about 0.005″.

In still yet another example of the first aspect, the coupling body is a single, monolithic body of material having one or more portions that are strain hardened and one or more portions that are not strain hardened.

In accordance with a second aspect, a fluid system includes a fluid element and a fluid fitting for mechanical attachment to a fluid element. The fluid fitting includes a coupling body having an inner surface defining a bore for receiving the fluid element therein, and a seal portion formed on the inner surface for engaging the fluid element. The fluid fitting further includes a ring configured to fit over at least one end of the coupling body for mechanically attaching the coupling body to the fluid element. When the ring is installed on the at least one end of the coupling body via force with the fluid element received in the bore, the ring applies a compressive force to the coupling body sufficient to cause permanent deformation of the coupling body such that a tooth of the seal portion bites into the fluid element to thereby attach the fluid element to the coupling body in a non-leaking manner. Moreover, at least one of the fluid element, the coupling body, and the ring includes duplex stainless steel.

In one example of the second aspect, the fluid element and the coupling body both include duplex stainless steel.

In another example of the second aspect, one of the fluid element and the coupling body includes duplex stainless steel, and the other of the fluid element and the coupling body does not include duplex stainless steel.

In yet another example of the second aspect, the tooth includes a cross-sectional profile that is substantially trapezoidal.

It is to be understood that both the foregoing general description and the following detailed description present example and explanatory embodiments. The accompanying drawings are included to provide a further understanding of the described embodiments and are incorporated into and constitute a part of this specification. The drawings illustrate various example embodiments of the invention.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is cross-sectional view of an example fluid fitting for mechanical attachment to a fluid element;

FIG. 2 is a detailed cross-sectional view of the fitting in a pre-installed configuration;

FIG. 3 is another detailed cross-sectional view of the fitting in an installed configuration;

FIG. 4A is a micrograph of the fluid element before attachment to the fluid fitting;

FIG. 4B is a micrograph of the fluid element after attachment to the fluid fitting;

FIG. 5 is a detailed cross-sectional view of an example tooth for the fitting;

FIG. 6 is a detailed cross-sectional view of another example tooth for the fitting;

FIG. 7A is a perspective view of a workpiece that can be processed to form an alternative coupling body for the fitting; and

FIG. 7B is cross-sectional view of the alternative coupling body formed from the workpiece in FIG. 7A.

### DETAILED DESCRIPTION

The following is a detailed description of illustrative embodiments of the present application. As these embodiments of the present application are described with reference to the aforementioned drawings, various modifications or adaptations of the methods and or specific structures described may become apparent to those skilled in the art. All such modifications, adaptations, or variations that rely upon the teachings of the present application, and through which these teachings have advanced the art, are considered to be within the spirit and scope of the present application. Hence, these descriptions and drawings are not to be considered in a limiting sense as it is understood that the present application is in no way limited to the embodiments illustrated. Moreover, certain terminology is used herein for convenience only and is not to be taken as a limitation. Still further, in the drawings, the same reference numerals are employed for designating the same elements.

Herein, when a range having a lower end point and upper end point is given, this means preferably at least or more than the lower end point and, separately and independently, preferably at most or less than the upper end point.

Moreover, the terms “about”, “substantial”, “substantially”, and variations thereof are intended to note that the described features are equal or approximately equal to a value or characteristic, as desired, reflecting tolerances, conversion factors, rounding off, measurement error and the like, and other factors. For example, a “substantially parallel” configuration of two elements is intended to denote the two elements are parallel or approximately parallel to each other. Moreover, the terms “about”, “substantial”, “substantially”, and variations thereof can denote values that are within about 10% of exact, for example within about 5% of exact, or within about 2% of exact. When the terms “about”, “substantial”, “substantially”, and variations thereof are used in describing a value or characteristic, the disclosure should be understood to include the exact value or characteristic being referred to. A range of values are established to account for geometric differences in designs developed to work on both the smallest and largest pipe size, and pipe sizes in between.

It is noted that the terms “about”, “substantial”, “substantially”, and variations thereof may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

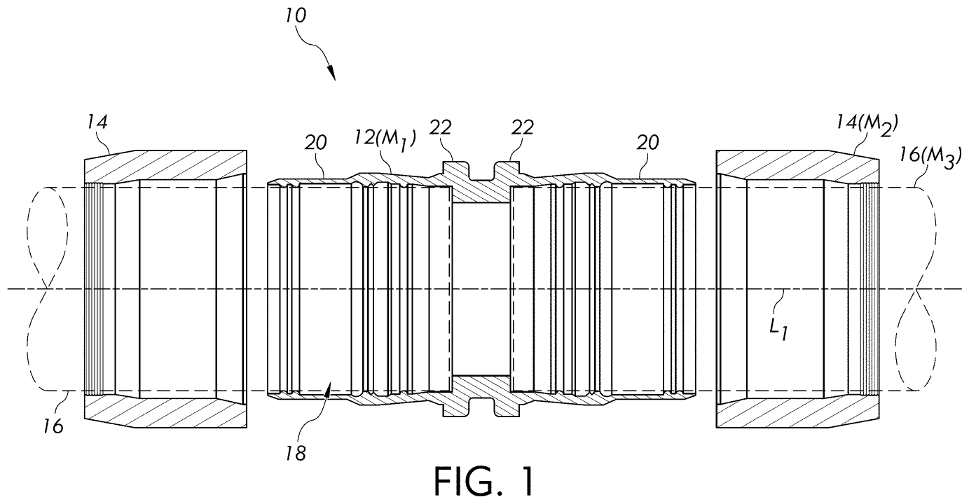

Turning to FIG. 1-3, an example fitting 10 is illustrated that can be connected to two or more fluid elements. For the purposes of this disclosure, a “fluid element” refers to a pipe, tube, fitting, or any other element that is configured to convey, deliver, and/or receive fluid). Moreover, a “fitting” refers to any element that can be connected to two or more fluid elements to fluidly couple the two or more fluid elements together.

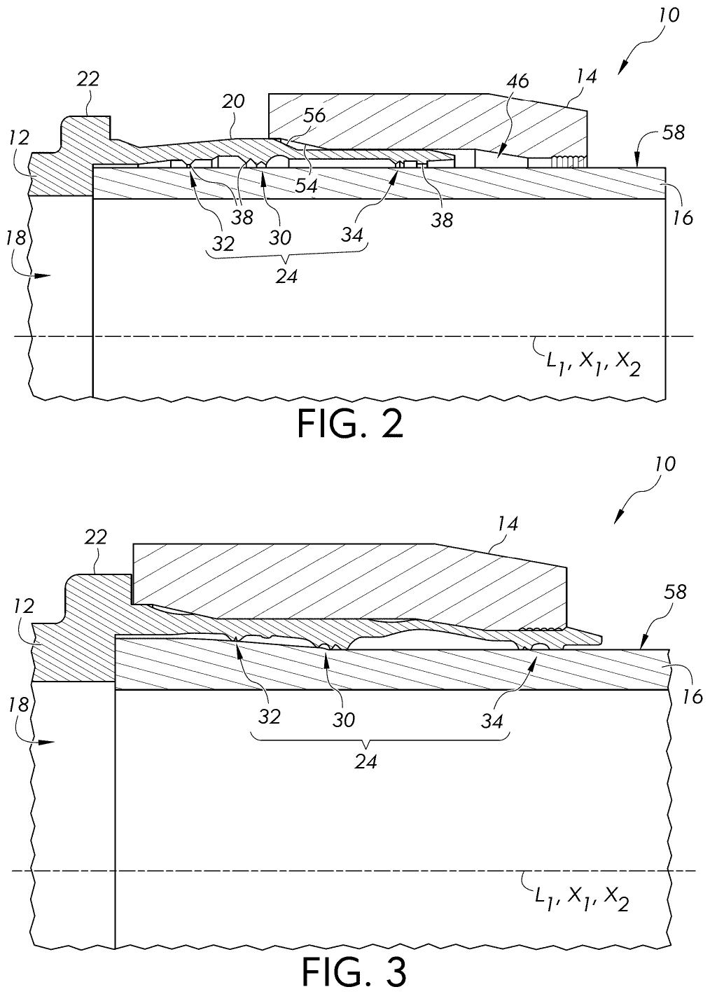

FIGS. 1-3 show cross-sectional views of the fitting 10 taken along a plane that is parallel to and contains a longitudinal axis L₁. The components of the fitting 10 as arranged in FIGS. 1-3 are generally symmetrical about the longitudinal axis L₁ such that they extend completely around the longitudinal axis L₁ in a symmetrical manner. FIG. 1 shows the components of the fitting 10 generally aligned along the longitudinal axis L₁. Meanwhile, FIGS. 2 & 3 respectively show one side of the fitting 10 (i.e., the right side as viewed in FIG. 1) in a pre-installed configuration and an installed configuration. It is understood that the opposite side of the fitting 10 (i.e., the left side as viewed in FIG. 1) can comprise a similar or identical configuration that is mirrored along the longitudinal axis L₁.

The fitting 10 in the present example includes a coupling body 12 and two drive rings 14 (sometimes referred to as “swage rings”) that can be slid over the coupling body 12 to join a pair of pipe bodies 16 to the fitting 10, as discussed further below. The pipes 16 that this application is applicable with/to can be thin walled or thick walled pipes, such as those ranging in size from ¼″ NPS to 4″ NPS, or even up to 6″ NPS or greater. Moreover, each pipe 16 can have a ratio (Do/t) of outside diameter (Do) divided by wall thickness (t) of between about 1 to about 100, about 2 to about 70, about 3 to about 40, or about 4.5 to about 30. However, other pipe sizes may also derive a benefit from the example fitting 10. Moreover, the fitting 10 can be similarly connected to other types of fluid elements such as flanges, tees, and other fittings.

TABLE 1
Ratio calculation of Diameter of pipe or tube to wall thickness (Do/t)

| Nominal Pipe Dimensions | | | | | | | | | Ratio of Do/t | | | | | |
|---|---|---|---|---|---|---|---|---|---|---|---|---|---|---|
| | | Wall | | Sched- | Sched- | Sched- | | | | Sched- | Sched- | Sched- | | |
| Nominal | | Thickness/ | Sched- | ule | ule | ule | Sched- | Sched- | Sched- | ule | ule | ule | Sched- | Sched- |
| Pipe Size | Outside | Inside | ule | 10/10 | 40/40 | 80/80 | ule | ule | ule | 10/10 | 40/40 | 80/80 | ule | ule |
| N.P.S. | Diameter | Diameter | 5 | S | S | S | 160 | XXS | 5 | S | S | S | 160 | XXS |
| ¼ | 0.540 | Wall | 0.049 | 0.065 | 0.088 | 0.119 | — | | 11.0 | 8.3 | 6.1 | 4.5 | | |
| | | I.D | | 0.410 | 0.364 | 0.302 | — | | | | | | | |
| ⅜ | 0.675 | Wall | 0.049 | 0.065 | 0.091 | 0.126 | — | | 13.8 | 10.4 | 7.4 | 5.4 | | |
| | | I.D | | 0.545 | 0.493 | 0.423 | — | | | | | | | |
| ½ | 0.840 | Wall | 0.065 | 0.083 | 0.109 | 0.147 | 0.187 | 0.294 | 12.9 | 10.1 | 7.7 | 5.7 | 4.5 | 2.9 |
| | | I.D | | 0.674 | 0.622 | 0.546 | 0.466 | | | | | | | |
| ¾ | 1.050 | Wall | 0.065 | 0.083 | 0.113 | 0.154 | 0.218 | 0.308 | 16.2 | 12.7 | 9.3 | 6.8 | 4.8 | 3.4 |
| | | I.D | | 0.884 | 0.824 | 0.742 | 0.614 | | | | | | | |
| 1 | 1.315 | Wall | 0.065 | 0.109 | 0.133 | 0.179 | 0.250 | 0.358 | 20.2 | 12.1 | 9.9 | 7.3 | 5.3 | 3.7 |
| | | I.D | | 1.097 | 1.049 | 0.957 | 0.815 | | | | | | | |
| 1¼ | 1.660 | Wall | 0.065 | 0.109 | 0.140 | 0.191 | 0.250 | 0.382 | 25.5 | 15.2 | 11.9 | 8.7 | 6.6 | 4.3 |
| | | I.D | | 1.442 | 1.380 | 1.278 | 1.160 | | | | | | | |
| 1½ | 1.900 | Wall | 0.065 | 0.109 | 0.145 | 0.200 | 0.281 | 0.400 | 29.2 | 17.4 | 13.1 | 9.5 | 6.8 | 4.8 |
| | | I.D | | 1.682 | 1.610 | 1.500 | 1.338 | | | | | | | |
| 2 | 2.375 | Wall | 0.065 | 0.109 | 0.154 | 0.218 | 0.343 | 0.436 | 36.5 | 21.8 | 15.4 | 10.9 | 6.9 | 5.4 |
| | | I.D | | 2.157 | 2.067 | 1.939 | 1.689 | | | | | | | |
| 2½ | 2.875 | Wall | 0.083 | 0.120 | 0.203 | 0.276 | 0.375 | 0.552 | 34.6 | 24.0 | 14.2 | 10.4 | 7.7 | 5.2 |
| | | I.D | | 2.635 | 2.469 | 2.323 | 2.125 | | | | | | | |
| 3 | 3.500 | Wall | 0.083 | 0.120 | 0.216 | 0.300 | 0.437 | 0.600 | 42.2 | 29.2 | 16.2 | 11.7 | 8.0 | 5.8 |
| | | I.D | | 3.260 | 3.068 | 2.900 | 2.626 | | | | | | | |
| 4 | 4.500 | Wall | 0.083 | 0.120 | 0.237 | 0.337 | 0.531 | 0.674 | 54.2 | 37.5 | 19.0 | 13.4 | 8.5 | 6.7 |
| | | I.D | | 4.260 | 4.026 | 3.826 | 3.438 | | | | | | | |

As shown in FIGS. 2 & 3, the coupling body 12 defines a bore 18 that extends through the coupling body 12 for receiving a pipe 16 therein at each end. Thus, the fitting 10 is used to fluidly couple the two pipes 16 in a sealed, non-leaking manner. The coupling body 12 extends symmetrically about a central axis X₁ of the bore 18, and includes a sleeve portion 20, a flange portion 22, and a seal portion 24. Moreover, the seal portion 24 includes at least one seal for connection to the exterior of the pipe 16, and in the illustrated embodiment includes a main seal 30, an inboard seal 32, and an outboard seal 34, wherein each seal 30, 32, 34 comprises one or more teeth 38 that extend radially inward from the sleeve portion 20. It is contemplated that the seal portion 24 could include other numbers and/or arrangements of seals. The drive ring 14 is similarly an open-center body that defines a bore 46 extending through the drive ring 14 for receiving coupling body 12 therein. Moreover, the drive ring 14 extends symmetrically about a central axis X₂ of the bore 46.

The coupling body 12 and drive ring 14 can be initially assembled in the pre-installed configuration shown in FIG. 2. Specifically, the drive ring 14 can be arranged over the end of the coupling body 12 such that the central axes X₁, X₂ of the coupling body 12 and drive ring 14 are collinear with the longitudinal axis L₁ and the coupling body 12 is arranged within the bore 46 of the drive ring 14. In this configuration, a ramped-up section 54 of the drive ring 14 will be adjacent, but slightly spaced relative to, a land section 56 of the coupling body 12. Through an interference fit, the drive ring 14 can be maintained on the coupling body 12 in the pre-installed configuration and shipped to customers, which facilitates ease of use and installation by the ultimate end-users.

To install the fitting 10 onto a pipe 16, the pipe 16 can be located within the bore 18 of the coupling body 12 while the fitting 10 is in its pre-installed configuration (FIG. 2). The drive ring 14 can then be forced axially along the longitudinal axis L₁ toward the flange portion 22 of the coupling body 12 until the fitting 10 assumes its installed configuration (FIG. 3). The drive ring 14 and coupling body 12 have a predetermined ratio of interference, such that axial movement of the drive ring 14 to the installed configuration causes the coupling body 12, drive ring 14, and pipe 16 to deform, thereby creating a mechanical connection of these elements with a metal-to-metal non-leaking seal between the pipe 16 and coupling body 12.

More specifically, as the drive ring 14 is forced axially along the longitudinal axis L₁ toward the flange portion 22, it applies a compressive force to the coupling body 12 that causes radial deformation of the body 12, forcing the teeth 38 of its seals 30, 32, 34 to bite into the pipe 16. The coupling body 12 in turn compresses the pipe 16 first elastically (i.e., non-permanent) and then plastically (i.e., permanent). This compression is sufficiently high to plastically yield the pipe 16 under the sealing lands, forming a 360° circumferential, permanent, metal-to-metal seal between the pipe 16 and the coupling body 12. Simultaneous with the radial compression of the body 12 and the pipe 16, the drive ring 14 expands radially outward. This radial expansion of the drive ring 14 is elastic, and results in a small increase in the diameter of the drive ring 14.

Setting of a seal is considered complete (i.e., fully set) when the seal's teeth 38 are completely forced into deforming contact with the pipe 16 (e.g., when an exterior surface 58 of the pipe 16 immediately opposite the seals 30, 32, 34 has no further radial movement as a result of being forced inward by a particular section of the drive ring 14). Alternatively, full setting of a seal(s) can be defined as when the drive ring 14 has forced the teeth 38 of the seal furthest into the pipe 16 or when an actuating taper of the drive ring 14 levels out to a diametrically constant cylindrical section as the drive ring 14 moves past the seal. The pipe 16 typically becomes strained beyond its elastic limit as the seals 30, 32, 34 continue to bite into the surface 58 and the pipe 16 begins to plastically deform or move radially inwardly resulting in permanent deformation. The teeth 38 of the seals 30, 32, 34 bite into and deform the exterior surface 58 of the pipe 16 and may themselves be somewhat deformed. This functions to fill any rough or irregular surface imperfections found on the outside of the pipe 16.

Once installed, the drive ring 14 will abut or engage the flange portion 22 (although it can be spaced from flange portion 22 in other examples). Moreover, because the drive ring 14 deforms elastically during installation such that it expands radially outward, the drive ring 14 will exert a continuous elastic force against the coupling body 12 and pipe 16 that is maintained after installation through the life of the fitting 10, thereby preventing release of the metal-to-metal seal between the pipe 16 and the coupling body 12.

As discussed above, the seal portion 24 of the coupling body 12 of the illustrated embodiment includes the main seal 30, inboard seal 32, and outboard seal 34, wherein each seal 30, 32, 34 comprises one or more teeth 38 that extend radially inward from the sleeve portion 20 and bite into the pipe 16 during installation of the fitting 10. In some embodiments, the seals 30, 32, 34 are preferably distributed over an axial length of the bore 18 that is between about 60% to about 75% times an outer diameter of the pipe 16. When the seals 30, 32, 34 are distributed within this range, loading on the fitting 10 imparted by stresses from extreme thermal exposure can be dissipated, and focal stress concentrations where material fatigue initiate can be reduced.

It is to be appreciated that various modifications can be made to the coupling body 12 and drive ring 14 of the fitting 10 without departing from the scope of this disclosure. For instance, the coupling body 12 can be a flange body, as discussed further below. Moreover, the coupling body 12 can be a T-shaped or Y-shaped body having more than two legs, and the fitting 10 can include multiple drive rings 14 that can each be forced over a different leg to connect the fluid fitting 10 to a fluid element. As another example, the coupling body 12 maybe configured to receive only one fluid element, and the fitting 10 may include only a single drive ring 14 to mechanically attach the coupling body 12 to the fluid element.

Broadly speaking, the coupling body 12 and drive ring 14 can be any body defining a bore therethrough such that the coupling body 12 can receive a fluid element and the drive ring 14 can be forced over the coupling body 12 to compress and mechanically attach the coupling body 12 to the fluid element. For instance, various example fittings with coupling bodies and drive rings are described in commonly owned U.S. Pat. Nos. 10,663,093; 8,870,237; 7,575,257; 6,692,040; 6,131,964; 5,709,418; 5,305,510; and 5,110,163, which are all expressly incorporated herein by reference in their entirety.

The terms “axial”, “radial”, and variations thereof have been used above in describing various features of the coupling body 12, drive ring 14, and pipe 16. It is to be appreciated that those terms as used above (and further below) are relative to the central axis of the element being described unless clearly indicated otherwise. That is, the terms “axial”, “radial”, and variations thereof when describing features of the coupling body 12 are relative to the coupling body's central axis X₁, when describing features of the drive ring 14 are relative to the drive ring's central axis X₂, and when describing features of the pipe 16 are relative to the pipe's central axis, unless clearly indicated otherwise. Moreover, it is understood that in configurations wherein the central axes of the coupling body 12, drive ring 14, and pipe 16 are collinear with each other and a common axis (see e.g., FIGS. 1-3), the terms “axial”, “radial”, and variations thereof when describing features of the coupling body 12, drive ring 14, and pipe 16 will similarly be relative to the common axis and all central axes of the coupling body 12, drive ring 14, and pipe 16.

It has been discovered by the present inventor that the fitting 10 described above and its mechanical attachment to the pipe 16 enables the use of materials for the fitting 10 and/or pipe 16 that typically are unsuitable for or encumber welded connections between pipes and fittings.

For example, the coupling body 12, drive ring 14, and pipe 16 in the present embodiment are monolithic bodies, meaning that each is a single body of material. In particular, the coupling body 12, drive ring 14, and pipe 16 respectively comprise a first material M₁, a second material M₂, and a third material M₃. Any or all of these materials M₁, M₂, M₃ can comprise a duplex stainless steel DSS having a dual phase microstructure consisting of both austenite and ferrite. The ferrite phase imparts greater strength to the duplex stainless steel DSS as compared with standard austenitic stainless steels, and provides significant resistance to chloride stress corrosion cracking (chloride is a corrosive chemical that is commonly found in industrial oil and gas installations of these fittings). Additionally, the austenitic phase provides sufficient ductility to the duplex stainless steel DSS. Ductility can reduce the occurrence of microcracks in the fitting 10 and/or pipe 16 that can happen during the installation process and permit corrosive chemicals to enter and eventually compromise the strength of the fitting 10.

The strength, anti-corrosion, and ductility of the duplex stainless steel DSS can be modified to achieve a desired purpose by varying the microstructure balance between austenite and ferrite. In one or more embodiments, the duplex stainless steel DSS can have an austenite-to-ferrite ratio (i.e., ratio of austenite mass divided by ferrite mass) of about 35% to about 65%, about 40% to about 60%, or about 45% to about 55%. In a preferred embodiment, the duplex stainless steel can have an austenite-to-ferrite ratio of about 50%.

A chemical composition of the duplex stainless steel DSS can comprise (by mass %): a minimum of about 25% mass chromium, a minimum of about 2% mass molybdenum, and a minimum of about 6.5% mass nickel. Moreover, the duplex stainless steel DSS used in this application is a super duplex steel having a PREN (i.e., Pitting Resistance Equivalent Number) of about 40 or a hyper duplex steel having a PREN of about 45 or greater. Preferably, the duplex stainless steel DSS is a super/hyper duplex steel having a balance of austenite and ferrite of between about 35% to about 65%, a PREN of about 40 minimum, and a chemical composition of a minimum of about 25% mass chromium, a minimum of about 2% mass molybdenum, and a minimum of about 6.5% mass nickel. However, the composition of the duplex stainless steel DSS can vary by embodiment, and the relative amounts of each metal in the duplex stainless steel DSS can be based on the service environment, manufacturer's recommendations, experience, etc.

The element(s) comprising the duplex stainless steel DSS (e.g., the coupling body 12, drive ring 14, and/or pipe 16) can be formed using cold working or cold forming processes that can mechanically enhance the duplex stainless steel DSS by means of a strain hardening technique. In some embodiments, the duplex stainless steel DDS can be strain-hardened to a hardness level of about Rockwell C-Scale 32.

For example, each element can be formed by a cold pilgering process in which a tapered mandrel is inserted into the bore of a workpiece (e.g., pipe or tube) comprising the duplex stainless steel DSS, and a pair of top and bottom dies are forced over and around workpiece's outside diameter. The mandrel maintains the workpiece's inside diameter while the dies reduce the outside diameter, thereby reducing the outer diameter and thickness of the workpiece in a single step.

As another example, each element can be formed by a cold drawing process in which a workpiece comprising the duplex stainless steel DSS is forced through a single die or a series of dies, thereby reducing the cross-section size of the workpiece. Cold drawing can achieve cross-sectional reductions of between about 15% to about 30%.

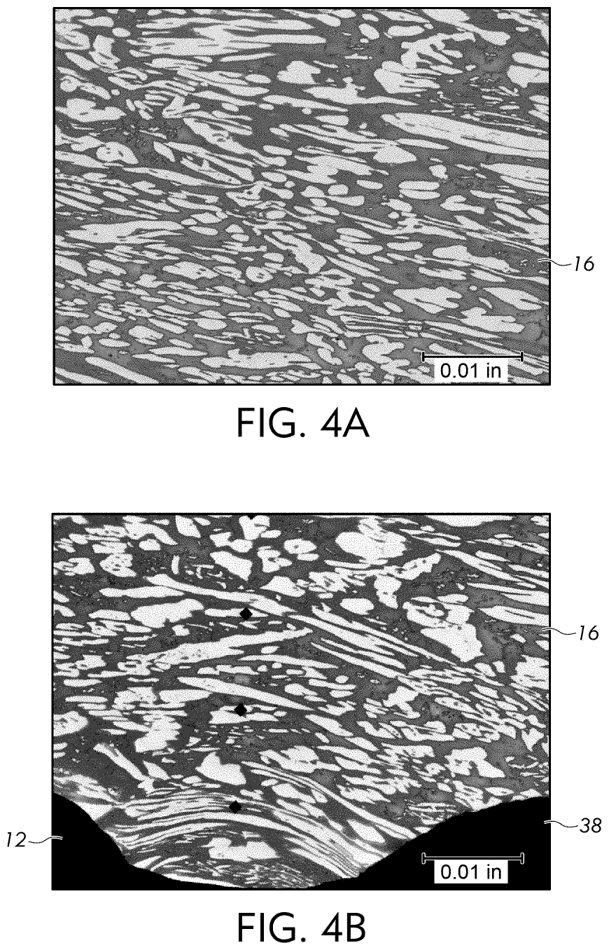

FIG. 4A shows an optical micrograph image of the pipe 16 comprising a duplex stainless steel material having a preferred microstructure balance for use with the fitting 10. The lighter regions represent the austenite content while the darker regions represent the ferrite content. FIG. 4B shows an optical micrograph image of the pipe 16 after being coupled to the fitting 10. As is evident in FIG. 4B, the pipe 16 was ductile enough to couple with the fitting 10 (shown in black) without significant change to its microstructure. These figures demonstrate that, unlike conventional fittings that are attached by welding, the present fitting 10 enables the pipe 16 and fitting 10 be mechanically coupled without any significant changes to the microstructure balance of duplex stainless steel materials. Thus, unlike in welding processes, duplex stainless steels are capable of maintaining their strength, ductility, and anti-corrosive properties more easily.

The coupling body 12, drive ring 14, and pipe 16 in the present embodiment each comprise the same duplex stainless steel material. However, it is to be appreciated that the coupling body 12, drive ring 14, and pipe 16 may comprise duplex stainless steel materials that are similar or substantially different from each other. For instance, the coupling body 12 and drive ring 14 can comprises a duplex stainless steel material that is different in composition, PREN, and/or balance of austenite and ferrite than a duplex stainless steel material of the pipe 16. Preferably, the duplex stainless steel materials M₁, M₂, M₃ for the coupling body 12, drive ring 14, and pipe 16 will be grades listed in ASME code ASME B31.3-2016 (e.g., for acceptable use in critical process and power piping).

Another benefit of the fitting 10 described above is that its mechanical attachment enables the fitting 10 and pipe 16 to comprise materials that are substantially different from each other, whereas conventional welding processes for connecting fittings and pipes require the components being welded together to have substantially similar composition. Thus, in some embodiments, one or more elements of the fitting 10 and pipe 16 (e.g., the coupling body 12 and drive ring 14) can comprise a duplex stainless steel material while one or more other elements (e.g., the pipe 16) can comprise a non-duplex stainless steel material including, but not limited to, carbon steel, low and intermediate alloy steel, and stainless steels. In cases where the fitting 10 comprises strain-hardened duplex stainless steel and is coupled to a pipe 16 comprising non-duplex stainless steel, the non-duplex stainless steel pipe 16 can have a yield strength of 80 ksi or lower. Moreover, the fitting 10 can be more resistant to the effects of bimetallic corrosion because duplex stainless steel is comparatively more noble, and thus more corrosion-resistant, than other steel alloys, such as carbon steel.

Still further, by forming the coupling body 12 with duplex stainless steel, unique seal geometries can be formed compared to coupling bodies that are made with less-ductile materials. More specifically, coupling bodies made with other metal alloys typically require sharp teeth to form an adequate seal with a fluid element. However, the use of duplex stainless steel can enable the teeth 38 of the coupling body 12 to have flatter or more-rounded profiles without sacrificing strength or the structural integrity of the seal.

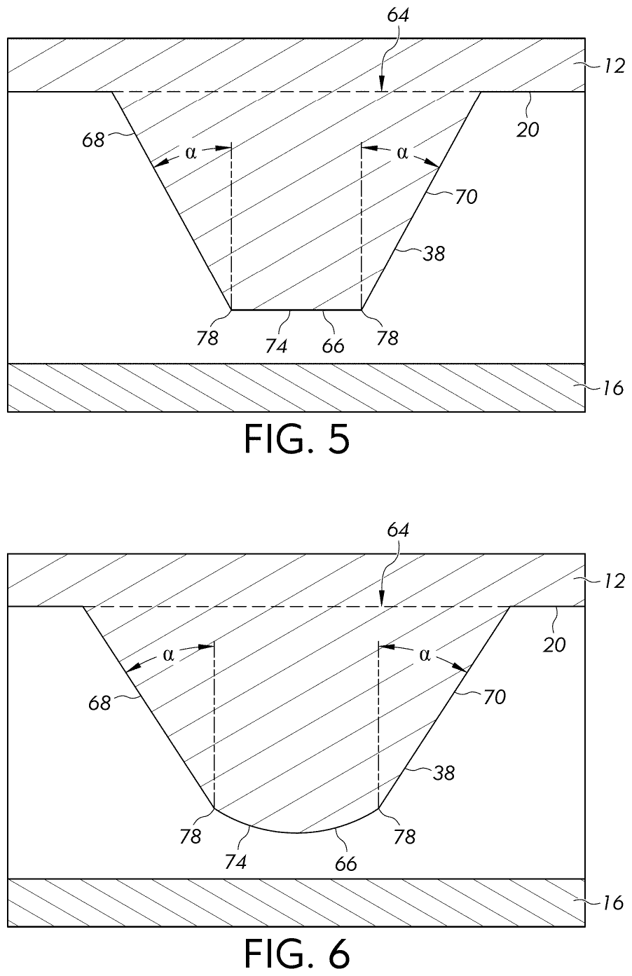

For instance, FIGS. 5 and 6 show different example configurations for each tooth 38 of the coupling body 12, both figures being cross-sectional views taken a plane that is parallel to and contains the central axis X₁. As shown in FIG. 5, each tooth 38 of the coupling body's seal portion 24 can extend radially inward from the sleeve portion 20 beginning at a root 64 to a distal end 66 of the tooth 38. Each tooth 38 can have an inboard flank 68, an outboard flank 70, and a distal face 74 that extends between the inboard and outboard flanks 68, 70 and intersects with them at respective edges 78. The flanks 68, 70 can be angled such that they extend oblique to the central axis X₁ of the coupling body 12. In particular, an angle α between each flank 68, 70 and the radial direction can be about 30 degrees to about 40 degrees. Moreover, the distal face 74 can have a cross-sectional profile that is substantially flat and extends substantially parallel to the central axis X₁.

In other examples (see e.g., FIG. 6), the flanks 68, 70 can be angled such that an angle α between each flank 68, 70 and the radial direction is about 40 degrees to about 50 degrees. Moreover, the cross-sectional profile of the distal face 74 can be rounded with a radius of curvature of about 0.010″ to about 0.050″. Whether flat or rounded, the cross-sectional profile will preferably have a length of about 0.005″ to about 0.040″ (for rounded profiles, it is understood that a “length” of the rounded profile refers to its arc length).

Each edge 78 can be a radiused edge having a relatively large radius of curvature, such that the interface between the respective flank 68, 70 and the distal face 74 of the tooth 38 is smooth and continuous, without any sharp or discrete transition. In other embodiments, each edge 78 can have a relatively small radius of curvature that is small enough to yield a discernible, discrete interface between the respective flank 68, 70 and the distal face 74 of the tooth 38. Such a discrete interface may approximate a sharp edge between the associated flank 68, 70 and distal face 74 of the tooth 38 when viewed from a distance. Preferably, each edge 78 will have a radius of curvature of about 0.003″ to about 0.005″. It is also to be appreciated that in some embodiments, the flanks 68, 70 may form a contoured surface with the distal face 74 such that no clearly defined edge exists between them.

Each tooth 38 can therefore have a substantially trapezoidal cross-sectional profile that is more robust and provides more mass to press down against the pipe 16 as compared to sharper teeth of conventional coupling bodies that comprise non-duplex stainless steels. Each tooth 38 can also be larger in mass compared to conventional teeth, which can enable the coupling body 12 to engage pipe surfaces of lesser quality.

Another benefit of the fitting 10 described above is the ability to reduce leakage of flammable liquids or gases, particularly when the fitting 10 is exposed to fire and/or high frequency vibration. This can be accomplished through the appropriate ratios of material development through strain hardening and interference between the coupling body 12, drive ring 14, and pipe 16 along the axial length of their contact areas. Moreover, the fitting 10 eliminates the need to heat treat welded connections as typically required for welds in corrosive environments.

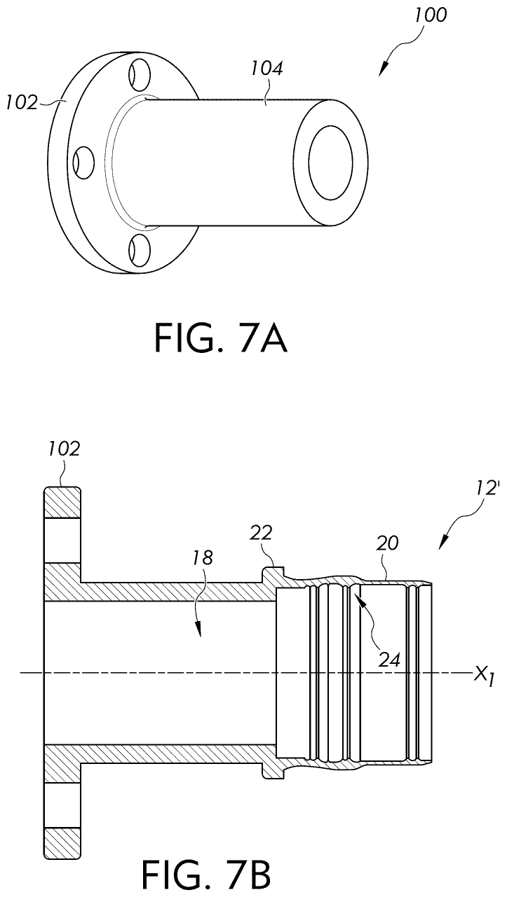

Turning to FIGS. 7A and 7B, a process of forming an example coupling body 12′ for the fitting 10 will now be described. As shown in FIG. 7A, an initial workpiece 100 is provided that comprises a single, monolithic body of duplex stainless steel in accordance with the description above. The workpiece 100 includes a flange portion 102 and a cylindrical portion 104 that extends from the flange portion 102. The cylindrical portion 104 can be cold worked to obtain desired material mechanical strength and material microstructure levels, and then machined under high tolerances to form the final coupling body 12′, as shown in FIG. 7B.

Thus, the final coupling body 12′ will be a single, monolithic body of duplex stainless steel. However, specific portions of the coupling body 12′ formed from the cylindrical portion 104 of the workpiece 100 (e.g., the sleeve portion 20, flange portion 22, and seal portion 24 of the coupling body 12′) will be strain hardened by the process of cold working reduction of material on the order of approximately 20% or less, depending on the chemistry of the material. Meanwhile, other portions of the coupling body 12′ (e.g., the flange portion 102) will not be strain hardened. Nevertheless, a transition area between portions of the coupling body 12′ that have been mechanically enhanced and not mechanically enhanced will maintain relatively uniform corrosion resistance through the balance of austenite and ferrite in the workpiece's base material.

It is to be appreciated that the process described above for forming the coupling body 12′ can be similarly applied to form other coupling bodies such as the coupling body 12 illustrated in FIGS. 1-3. That is, an initial workpiece can be cold worked and then machined to form the coupling body 12 in FIGS. 1-3 or some other type of coupling body for a fluid fitting. Similarly, various other types or configurations of coupling bodies can be manufactured using the methods and materials discussed herein, including but not limited to a 90-degree elbow, a T-Shape, adapters, caps, elbow at various angles, reducers, Tees, unions, etc.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A fluid fitting for mechanical attachment to a fluid element, comprising:
a coupling body defining a bore for receiving said fluid element therein, the coupling body comprising a sleeve portion and a tooth that extends radially inward from the sleeve portion for engaging said fluid element; and
a ring configured to fit over at least one end of the coupling body for mechanically attaching the coupling body to said fluid element,
wherein when the ring is installed on the at least one end of the coupling body via force with the fluid element received in the bore, the ring applies a compressive force to the coupling body sufficient to cause permanent deformation of the coupling body such that the tooth of the coupling body bites into said fluid element to thereby attach the coupling body to said fluid element in a non-leaking manner, and
wherein at least one of the coupling body and ring comprises duplex stainless steel.

2. The fluid fitting according to claim 1, wherein the coupling body and ring both comprise duplex stainless steel.

3. The fluid fitting according to claim 1, wherein one of the coupling body and the drive ring comprises duplex stainless steel, and the other of the coupling body and the drive ring does not comprise duplex stainless steel.

4. The fluid fitting according to claim 1, wherein the duplex stainless steel comprises an austenite-to-ferrite ratio of about 35% to about 65%.

5. The fluid fitting according to claim 1, wherein the duplex stainless steel comprises a minimum of about 25% mass chromium.

6. The fluid fitting according to claim 1, wherein the duplex stainless steel comprises a minimum of about 2% mass molybdenum.

7. The fluid fitting according to claim 1, wherein the duplex stainless steel comprises a minimum of about 6.5% mass nickel.

8. The fluid fitting according to claim 1, wherein the duplex stainless steel comprises a PREN of about 40 or greater.

9. The fluid fitting according to claim 1, wherein the tooth comprises a cross-sectional profile that is substantially trapezoidal.

10. The fluid fitting according to claim 1, wherein:
the bore of the coupling body has a central axis that defines an axial direction and a radial direction of the coupling body,
the tooth comprises an inboard flank, an outboard flank, and a distal face that extends between the inboard flank and outboard flank, and
the inboard flank and the outboard flank extend oblique to the radial direction.

11. The fluid fitting according to claim 10, wherein an angle between the radial direction and each of the inboard flank and the outboard flank is about 30 degrees to about 50 degrees.

12. The fluid fitting according to claim 10, wherein a cross-sectional profile of the distal face is substantially flat.

13. The fluid fitting according to claim 10, wherein a cross-sectional profile of the distal face is rounded with a radius of curvature of about 0.010″ to about 0.050″.

14. The fluid fitting according to claim 10, wherein a cross-sectional profile of the distal face has a length of about 0.005″ to about 0.040″.

15. The fluid fitting according to claim 10, wherein the distal face intersects with the inboard flank and the outboard flank at respective edges, each edge having a radius of curvature of about 0.003″ to about 0.005″.

16. The fluid fitting according to claim 1, wherein the coupling body is a single, monolithic body of material having one or more portions that are strain hardened and one or more portions that are not strain hardened.

17. A fluid system comprising:
a fluid element; and
a fluid fitting for mechanical attachment to a fluid element, the fluid fitting comprising:
a coupling body having an inner surface defining a bore for receiving the fluid element therein, and a seal portion formed on the inner surface for engaging the fluid element, and
a ring configured to fit over at least one end of the coupling body for mechanically attaching the coupling body to the fluid element,
wherein when the ring is installed on the at least one end of the coupling body via force with the fluid element received in the bore, the ring applies a compressive force to the coupling body sufficient to cause permanent deformation of the coupling body such that a tooth of the seal portion bites into the fluid element to thereby attach the fluid element to the coupling body in a non-leaking manner, and
wherein at least one of the fluid element, the coupling body, and the ring comprises duplex stainless steel.

18. The fluid system according to claim 17, wherein the fluid element and the coupling body both comprise duplex stainless steel.

19. The fluid system according to claim 17, wherein one of the fluid element and the coupling body comprises duplex stainless steel, and the other of the fluid element and the coupling body does not comprise duplex stainless steel.

20. The fluid system according to claim 17, wherein the tooth comprises a cross-sectional profile that is substantially trapezoidal.
